(19) United States
(12) Patent Application Publication
(10) Pub. No.: US 2003/0179386 A1
(43) Pub. Date: Sep. 25, 2003

(54) Method for aligning a trapped microscopic particle along a selected axis and device operating accordingly

(75) Inventors: Enrico Santamato, Napoli (IT); Antonio Sasso, Napoli (IT); Bruno Piccirillo, Napoli (IT)

Correspondence Address: SUGHRUE MION, PLLC, 2100 Pennsylvania Avenue, NW, Washington, DC, 20037-3213, US

(73) Assignee: INFM - ISTITUTO NAZIONALE PER LA FISICA DELLA MATERIA

(21) Appl. No.: 10/096,253

(22) Filed: Mar. 13, 2002

(51) Int. Cl. G01B 11/14

(52) U.S. Cl. 356/614

(57) ABSTRACT

A device for aligning a trapped microscopic particle along a selected axis of alignment, comprises

a laser source emitting a laser beam,

one or more mirrors to convey the laser beam into a trapping region of the microscopic particle,

one or more astigmatic lenses capable to focus the laser beam in the trapping region.

A trapped microscopic particle is aligned along a selected axis of alignment by:

positioning the microscopic particle in a region where it can be illuminated by the laser beam,

fixing the alignment axis of the microscopic particle,

conveying the laser beam into the region of positioning of the microscopic particle,

focussing the laser beam in the region of positioning of the microscopic particle so that the beam shows a cross section which is elongated along a chosen direction, the chosen direction being calculated as a function of the alignment axis of the microscopic particle.

### DESCRIPTION

The present invention relates to a method for aligning a trapped microscopic particle along a selected axis according to the preamble to the main claim. Moreover the present invention concerns a device for rotating a trapped microscopic particle in accordance with the aforementioned method.

A recently developed device for trapping microscopic particles is the single-beam gradient trap, known as optical tweezers, which is a unique tool for micro-manipulation, enabling its user to access tiny object without any mechanical contact. It uses a focussed laser beam to trap and manipulate microscopic particles in the size range 100 nm-100 mm. The trap consists of a single laser beam which attracts particles towards its focal region. In particular, optical tweezers make use of the optical gradient force, that is for particles of higher refractive index than their surrounding medium, the laser beam induces a force attracting the trapped particle into the region of highest light intensity. The laser beam is also normally introduced into a conventional optical microscope, so that the same objective is used to view and trap particles.

The ability to rotate objects offer a new degree of control for microobjects and has important applications in optical micromachines and biotechnology. To achieve this goal, several attempts have been made and various methods have been investigated to induce rotation of trapped particles within optical tweezers.

Transfer of angular momentum from light to matter was proposed a long time ago (R. A. Beth, Phys. Rev. 50, 115 (1936)) as an effective tool to achieve this angular manipulation of microscopic objects. Following this method, the photon spin angular momentum was transferred to a trapped particle producing a tiny torque that was measured. However, since only the spin part of the photon angular momentum is involved, this mechanism requires polarised light and birefringent materials, which are not so widely used. Moreover, this method is difficult to control.

Another technique, in which the photons' orbital angular momentum is transferred, uses a Laguerre-Gaussan light beam (L. Allen et al., Phys. Rev. A 45, 8152 (1992)), which have a phase singularity. To transfer orbital angular momentum to a trapped particle with such a beam, the particle must absorb some of the laser light, which restricts the range of particles to which this method can be applied and the particle itself can be damaged by the heating that arises from this absorption.

In addition, the use of elliptically polarised light beams or beams of helical phase structure is complicated and it is difficult to achieve high power in such experiments, therefore limiting the achievable rotation rates of the particle.

The problem underlying the present invention is that of providing a method for rotating a trapped microscopic particle which at the same time overcomes the limitations explained above with reference to the prior art mentioned.

This problem is solved by the present invention by means of a method and a device for rotating a trapped microscopic particle in accordance with the appended claims.

The characteristics and the advantages of the invention will become clearer from the detailed description of one embodiment thereof which is described by way of non-limiting example, with reference to the appended drawings, in which:

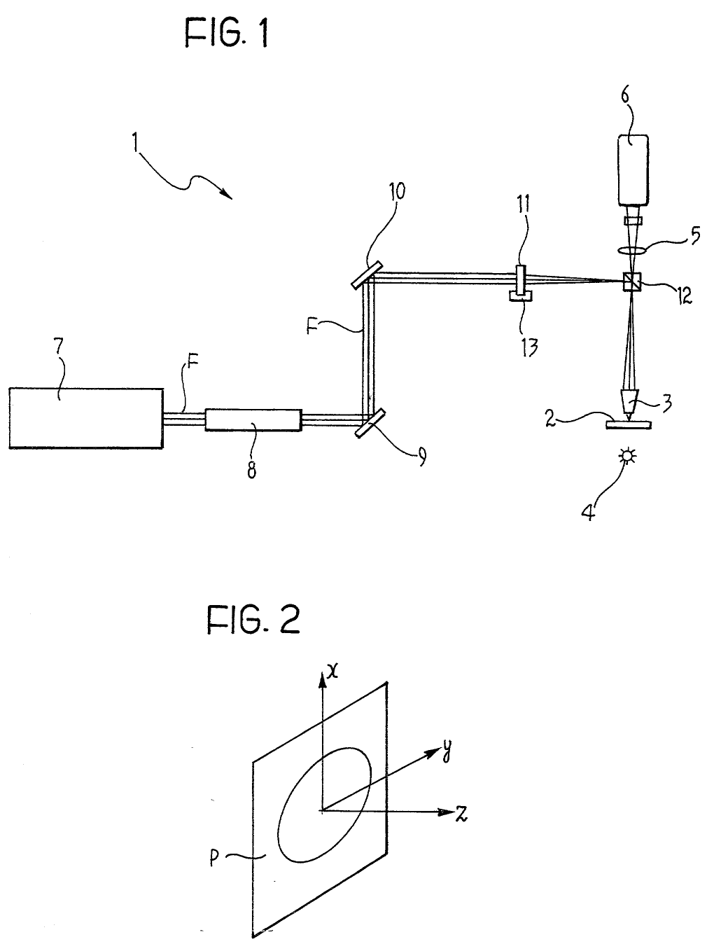

FIG. 1 is a schematic plan of a device formed in accordance with the present invention;

FIG. 2 is a schematic cross section of a laser beam used in accordance with the method of the present invention.

With reference to FIG. 1, a device for rotating a trapped microscopic particle formed in accordance with the present invention is generally indicated 1.

The device 1 comprises a microscope 2 including an objective 3, in particular a 40× high numerical aperture (NA=0.87 in water) microscope objective. An object, for example a microscopic particle, placed in a focal plane P of the objective 3 is illuminated by a white light 4 and its observation is achieved through an ocular system 5 and a camcorder 6.

Moreover, the device 1 comprises a laser source 7 emitting a laser beam F and, downstream with respect to the source, a zoom beam expander 3, to expand in a controlled way the beam waist of the source, so that a complete illumination of the object to be trapped can be achieved, as explained in detail below. In particular, a commercial cw frequency-doubled Nd:YVO₄ source working at λ=532 nm is used, whose state of polarisation is not influential (the laser beam can be polarised or unpolarised).

The laser beam F can be represented as a superposition of an infinite number of Laguerre-Gauss modes, each mode having a well defined orbital angular momentum hl, where l=0, 1, 2 . . . , in which l is even and l and −l equiprobable. The incident laser power ranges from 300 mW to mW at the focal plane P, position of the particle. At P the beam propagates along a direction z, perpendicular to P (see FIG. 2).

A mirror system comprising a first and a second mirror 9, 10 conveys the laser beam F into the focal plane P so that the microscopic particle to be observed can be trapped in P.

The laser beam F is then splitted in two sub-beams by a beam splitter 12 and conveyed into the microscope 2.

According to a particular characteristic of the present invention, the device 1 comprises an astigmatic lens 11, for example cylindrical, located between the second mirror 10 and the beam splitter 12, to focus the laser beam F in the focal plane P. In particular, the focusing obtained by the astigmatic lens 11 is such that the cross section of the intensity profile of the laser beam F in the plane P is asymmetric, that is it has an elongated shape along a chosen direction. When the astigmatic lens is cylindrical, the cross section is an ellipse whose elongate direction corresponds to its major axis.

By way of example, two confocal cylindrical lenses are used, so that the laser intensity profile at the particle position is made elliptical. The two lenses have focal lengths fₓ=500 mm and f_{y}=30 mm in the x and y direction respectively (where the directions x and y are perpendicular to each other and to z). The beam radii (1/e² intensity) at the lens common focal plane P is found to be wₓ=130 μm and w_{y}=10 μm, corresponding to a profile ellipticity μ=w_{x/w}_{y}=13.

The astigmatic lens 11 is mounted on regulating means 13 so that it can be rotated around the laser beam axis to change the orientation of the intensity profile. In such a way, the major axis of the ellipse can be aligned along any selected axis.

According to the method of the invention, a microscopic particle, assumed isotropic, is positioned into the focal plane P and trapped switching the laser beam F on.

An alignment axis, along which the microscopic particle is desired to be observed, is fixed. As an example, this fixed alignment axis forms an angle of 90° with the initial position of the particle.

Therefore, the laser is switched off and the cylindrical lens 11 is rotated of 90°. The laser is again switched on the particle is immediately observed to start rotating until the alignment along the major axis of the beam intensity profile is established. In such a way the particle can be observed along any desired direction, simply rotating the cylindrical lens through the regulating means 13.

In this case, the alignment axis results parallel to the major axis of the intensity profile. If the particle were not isotropic, the relationship between the alignment axis and the direction defined by the major axis of the intensity profile would not be so simple, however the latter can always be calculated as a function of the former.

The particle is assumed isotropic, to rule out any effect related to photon spin. Illuminating the particle by the laser beam F, an incident photon of the beam is scattered from a state with orbital angular momentum h\vec{r}×\vec{k} to a state with orbital angular momentum h\vec{r}×\vec{k}′ where \vec{k} and \vec{k}′ are the incident and scattered photon wavevectors respectively. The particle located in P receives an amount \vec{l}=h\vec{r}×(\vec{k}′−\vec{k}) of angular momentum per photon.

The overall torque M acting on the body is given by M=∫\vec{l}φ(x,y)dxdy, where φ(x,y)is the photon flux in the (x,y) plane (orthogonal to the beam F).

The light intensity I(x,y) is related to the photon flux by I(x,y)=hνφ(x,y), ν being the optical frequency. Using the paraxial approximation, M may be written down as

$$M = \frac{P}{2 π v} < {r}^{->} \times ∇ ( ψ - {ψ}^{′} ) > , \qquad ( Eq . ( 1 ) )$$

where P is the incidental optical power, <.> means the spatial average over the beam intensity profile and ψ the optical phase (\vec{k}=∇ψ). The difference (ψ−ψ′) is the phase change the optical wave suffers traversing the particle.

For a transparent particle of refractive index n immersed in a fluid of refractive index n₀, we have

$${ψ}^{′} - ψ = \frac{2 π}{λ} ( n - {n}_{0} ) d ( x , y )$$

where d(x,y) is the local thickness of the particle and λis the optical wavelength in vacuum.

For the sake of simplicity, a Gaussian beam shape is assumed, with radii wₓ and w_{y} along the x and y direction, respectively, and the particle is assimilated to a thin cylindrical lens with an effective focal length f and oriented at an angle α with respect to the x axis. Under these assumptions, the phase change becomes

$${ψ}^{′} - ψ = - \frac{π}{λ f} {( x cos α - y sin α )}^{2}$$

and the explicit evaluation of Eq. (1) gives for the z-component M_{z}

$${M}_{z} = \frac{P ( {w}_{x}^{2} - {w}_{y}^{2} )}{4 cf} sin 2 α = A sin 2 α ,$$

where c is the speed of light. In case of overdamped rotator, the equation of motion is

$$- γ \frac{ⅆ α}{ⅆ t} = {M}_{z}$$

whose solution starting at α(0) at time t=0 is given by

tan α(t)=e^{-t/τ} tan α(0),

with time constant τ=γ/2α. From this last equation it can be seen that, asymptotically in time, the microscopic particle tends to become aligned with the major axis of the intensity profile (which is, in this example, the x axis), because the light orbital angular momentum reorients the trapped particle.

If anisotropic particle were used, both the spin and the angular momentum of light could be simultaneously transferred in the process outlined above, inducing competition effects and complex dynamics. However also in this case a good alignment with a selected axis can be achieved, even if the equations are not as simple as the ones written above.

The invention thus solves the problem indicated, achieving many advantages over known methods or devices for aligning a trapped microscopic particle along a selected axis of alignment.

In the first place, the device of the invention defines an optical tweezers by which transparent isotropic particle can be trapped and rotated at will. In this way, heating problems are avoided even at high power laser intensity.

Moreover, there is no need to prepare the laser beam in a state carrying a non zero angular momentum, avoiding the problem of finding out exotic laser source, having a phase singularity.

Not least, the device and the method of the invention can be used to trap and align any kind of particle, such as transparent, opaque, isotropic, anisotropic, birefringent particles.

The method of the invention can also be used to realise optically driven micromachines, to measure torque on microscopic scale and to drive the rotational Brownian motion.

What we claim is:

1. A method for aligning a trapped microscopic particle along a selected axis of alignment, comprising the steps of:
providing a laser source to emit a laser beam,
positioning the microscopic particle in a region where it can be illuminated by the laser beam,
fixing the alignment axis of the microscopic particle,
conveying the laser beam into the region of positioning of the microscopic particle,
focussing the laser beam in the region of positioning of the microscopic particle so that the beam shows a cross section which is elongated along a chosen direction, the chosen direction being calculated as a function of the alignment axis of the microscopic particle.

2. The method of claim 1 wherein the laser beam is substantially monochromatic.

3. The method of claim 1 wherein the cross section of the laser beam is substantially elliptical.

4. The method of claim 1 wherein the chosen direction is substantially parallel to the alignment axis of the microscopic particle.

5. The method of claim 1 wherein the laser beam has average angular momentum equal to zero.

6. The method of claim 1 wherein the laser beam is unpolarised.

7. The method of claim 1 wherein the chosen direction is adjustable.

8. A device for aligning a trapped microscopic particle along a selected axis of alignment, comprising
a laser source emitting a laser beam,
one or more mirrors to convey the laser beam into a trapping region of the microscopic particle,
one or more astigmatic lenses capable to focus the laser beam in the trapping region.

9. The device of claim 8 wherein at least one of the astigmatic lenses is adjustable so that the focusing of the laser beam can be varied.

10. The device of claim 8 wherein one or more of the astigmatic lenses is cylindrical.

11. The device of claim 8 wherein a cross section of said laser beam taken in the trapping region has an elongated shape along a chosen direction.

12. The device of claim 11 wherein the cross section is an ellipse.

13. The device of claim 11 wherein the chosen direction is parallel to the axis of alignment.

14. The device of claim 8 wherein the microscopic particle is transparent.

15. The device of claim 8 wherein the microscopic particle is opaque.

16. The device of claim 8 wherein the microscopic particle is birefringent.

17. The device of claim 8 wherein the microscopic particle is isotropic.
